(19) United States
(12) Patent Application Publication
(10) Pub. No.: US 2002/0148911 A1
(43) Pub. Date: Oct. 17, 2002

(54) Portable fragrant air delivery/diffuser system for spas/hot tubs and other self powered air producing devices

(76) Inventors: Arnold W. Beck, Mesa, AZ (US); Kelley D. Beck, Mesa, AZ (US); Barry L. Landwert, Homeworth, OH (US)

Correspondence Address: Arnold W. Beck, 1920 East Jensen Street, Mesa, AZ, 85203, US

(21) Appl. No.: 10/066,364

(22) Filed: Jan. 29, 2002

Related U.S. Application Data
(60) Provisional application No. 60/266,839, filed on Feb. 6, 2001.

(51) Int. Cl. B05B 7/26

(52) U.S. Cl. 239/310

(57) ABSTRACT

A portable fragrant air delivery/diffuser system for spas/hot tubs and other self powered air producing devices comprising a portable vented container (FIG. 18 numeral 8), replaceable biodegradable filter (FIG. 18 numeral 6), multi-purpose removable cap (FIG. 18 numeral 5), vented bottom plate (FIG. 18 numeral 10) and an alternative use snap ring pivoting clip (FIG. 20g). The completely assembled unit, referred to as the Aroma Blast Unit (FIG. 18 numeral 12) is designed to fit into the aroma therapy chamber of newly manufactured spa/hot tubs FIG. 22 numeral 12) and to deliver natural plant derived oil fragrances to the therapy jet heads of said spa/hot tubs via the spa/hot tub's aroma therapy chamber and water boost pump plumbing (FIG. 22). Filter replacement is a simple process (FIG. 20d), thus providing the end user a means to choose from a variety natural plant derived oil fragrances to enjoy, or change as often as desired. The alternative snap ring clip (FIG. 20g numeral 16) snaps around the Aroma Blast Unit (FIG. 20b) whereby providing a method to attach to other self powered air producing devices (FIG. 20c), making it perfect for travel while providing an effective, inexpensive, durable and portable natural plant derived oil diffuser, that when clipped to other air producing devices helps eliminate bacteria, disinfects and freshens the surrounding air with the healthy fragrances of natural plant derived oils, not harsh chemicals. It can also be used as a stand alone air freshener (FIG. 20a) simply by standing it on its multi-purpose cap (FIG. 20a). The simplicity of design creates an effective, versatile, portable, virtually maintenance free product for the end user to enjoy for years to come.

This application is entitled to the benefit of Provisional Patent Application Ser. No. 60/266839 filed Feb. 6, 2001.

### BACKGROUND—FIELD OF INVENTION

This invention relates to spas/hot tubs, specifically to an original method to disperse, diffuse, vaporize, change and deliver safe, healthy fragrances created with easy to obtain, plant derived oils to a spa/hot tub's water therapy jet heads, without adding the oils directly to the water and to its surrounding air/environment when used in one of its portable alternative modes.

### BACKGROUND—DESCRIPTION OF PRIOR ART

No patented prior art found during our computer search; however, a current method incorporates a plastic disposable sealed container with permanently incased, chemically scented, synthetic, solid dry beads to deliver scented fragrances to the water therapy jet heads of spas/hot tubs. This method has the following significant disadvantages to the end user,

the plastic disposable container and permanently sealed chemically scented synthetic solid dry beads are not biodegradable and pose possible environmental hazards when discarded;

this method lacks the ability to change or replace fragrances without purchasing and replacing the entire disposable plastic sealed container which holds the synthetic solid dry beads;

the dry beads are produced from a solid type media and when packed into the disposable container restricts air flow through the aromatherapy chamber in spa/hot-tubs, thereby rendering this method much less effective in delivering the scented fragrances to the spa/hot-tub's water therapy jet heads;

an end user must choose from a limited selection of scented fragrances offered by manufacturer;

fragrances from the synthetic solid dry beads are short lived;

the end user does not have the ability to create personal unique fragrances;

and this method is limited to spa/hot tub use only, offering no other advantages or portable alternative uses to the end user.

### SUMMARY

In accordance with our present invention, a system to disperse, diffuse, vaporize, change and deliver safe, healthy fragrances created with easy to obtain, natural plant derived oils to the spa/hot-tub's water therapy jet heads, via its aromatherapy chamber and water boost pump plumbing without applying the oils directly to the water, comprising a portable vented container, a replaceable biodegradable filter, multi-purpose removable cap, for easy filter replacement or fragrance change, and a snap ring pivoting clip, that when snapped to our invention enables it to be attached to other self powered air producing devices, transforming it into a diverse, durable, portable, entry level, inexpensive, diffuser capable of effectively diffusing fragrances while deodorizing, disinfecting and freshening its surrounding air/environment.

### DRAWING FIGURES

FIG. 18 is an exploded view taken from a semi-inverted position demonstrating the assembly of our invention, assigns identification numbers to each part of our invention and displays a view that illustrates the fully assembled invention, ref. numeral 12.

FIG. 20 is a view displaying the separate parts that make up an alternative use snap ring pivoting clip 16 ref. FIG. 20g, assigns numbers to each of the parts and illustrates a few of the portable alternative uses for this invention, ref. FIG. 20a and 20c.

FIG. 22 illustrates the preferred use and method of operation of our invention, displaying it fully assembled, ref. numeral 12, inside the spa/hot tubs aromatherapy chamber.

### REFERENCE NUMERALS IN DRAWING

| | | | |
|---|---|---|---|
| 5 | multi-purpose cap | 12 | assembled delivery system |
| 6 | biodegradable plant fiber filter | 14 | snap ring |
| 7 | filter housing opening | 15 | pre-manufactured clip |
| 8 | filter housing | 6 | fully assembled alternative |
| | | | use snap ring clip |
| 9 | filter housing air | 10 | vented bottom plate |
| | intake/exhaust holes | | |

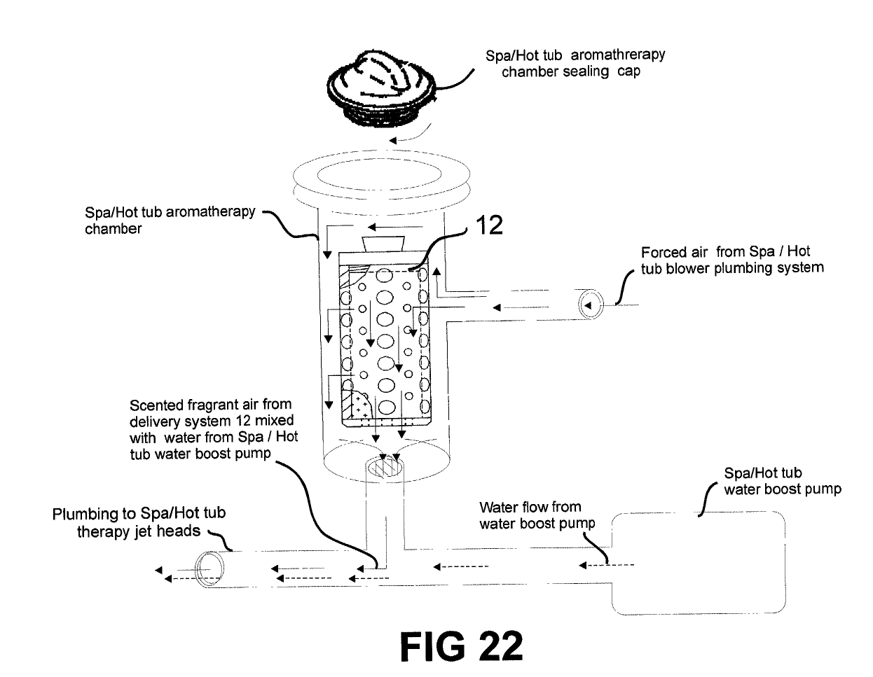

### DESCRIPTION—FIG. 22 PREFERRED EMBODIMENT

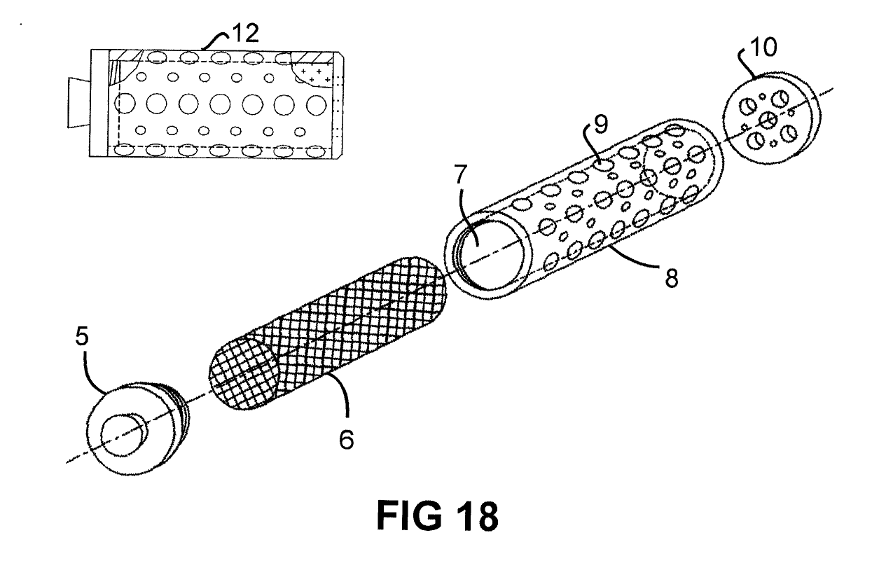

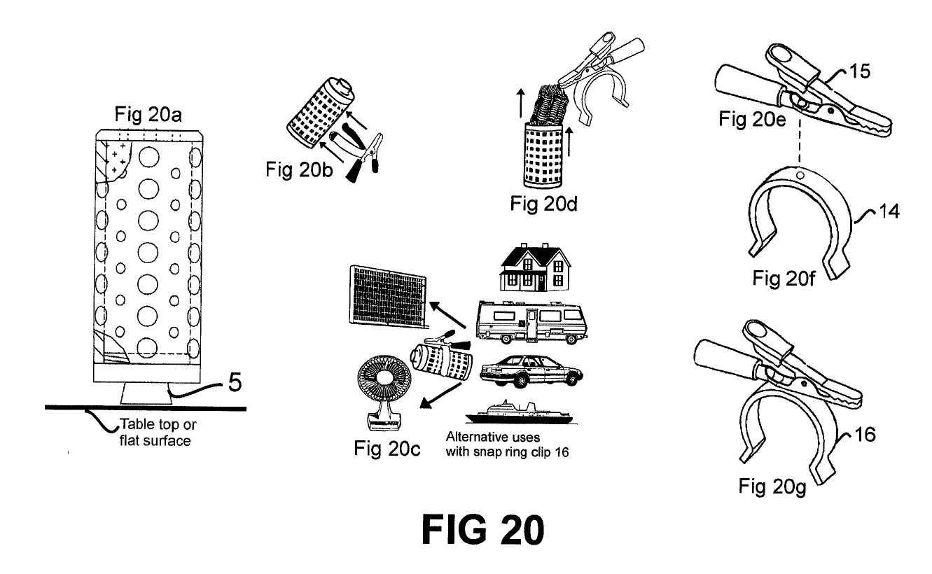

A preferred embodiment of our invention, is illustrated fully assembled in FIG. 22, numeral 12. Referencing FIG. 18, our invention, comprising a potable vented, open-ended container, referred to as filter housing 8, a filter housing opening 7, filter housing air intake/exhaust holes 9, a vented bottom plate 10, a multi-purpose cap 5, a biodegradable plant fiber filter 6, an alternative use snap ring pivoting clip 16, ref. FIG. 20g, comprising a snap ring 14, ref. FIG. 20f and a jawed, pre-manufactured clip 15, ref. FIG. 20e. Clip 15 is riveted to snap ring 14 in such a manner as to allow free pivoting around snap ring 14, ref. FIG. 20e and FIG. 20f. Referencing FIG. 18, filter housing 8 is manufactured from specific sized extruded plastic material cut to a pre-determined length. The bottom plate 10, cap 5 and snap ring 14 are manufactured from plastic by an injection molding process. Cap 5 and bottom plate 10 are molded to specific dimensions with a slight reverse taper on one end, providing them a method to attach to their perspective ends on filter housing 8 with a snap, lock in motion. Filter 6 is manufactured from an absorbent, biodegradable, plant fiber material, formed to a specific size and density by a hand rolling method that ensures proper air flow and absorbability. Our invention is assembled as follows:

The bottom plate 10 snaps into one end of filter housing 8, filter 6 is then inserted into the filter housing 8 via opening 7, cap 5 snaps into the filter housing opening 7, whereby securing filter 6. Disassembly for cleaning purposes is accomplished in the reverse order.

### FIG. 20C—ALTERNATIVE EMBODIMENTS

There are several other portable alternative uses for our invention when attached to other self-powered air producing devices with snap ring clip 16; as illustrated in FIG. 20b and 20c, our invention transforms into a portable, easy to operate, inexpensive, entry level scented air diffuser that diffuses safe, healthy fragrances created with easy to obtain, natural, plant derived oils, to its surrounding air/environment, providing the end user years of trouble free enjoyment.

### OBJECTS AND ADVANTAGES

Accordingly, the advantages of our invention over a current method being used, comprising a deposable plastic container that permanently seals the chemically scented, synthetic solid dry beads are as follows:

our invention uses safe, easy to obtain, natural, plant derived oils to create fragrances, not harsh chemicals;

the end user has the option to create their own unique fragrances by simply blending the natural plant derived oils;

filter 6 is biodegradable and does not pose any known threat to the environment when discarded;

filter 6 has a density that allows for proper air flow through it, thereby delivering maximum scented fragrances to the water therapy jet heads in said spa/hot tubs while providing extended enjoyment time from a selected fragrance.

filter 6 can be easily replaced, giving the end user an option to easily change fragrances without having to purchase a complete new disposable system;

our invention can be used as a stand alone air freshener with the aid of cap 5, as illustrated in FIG. 20a, numeral 5.

and our invention has the ability to be utilized in several portable alternative applications with the use of snap ring clip 16, as illustrated in FIG. 20c.

### OPERATION

Our invention disperses, diffuses, and vaporizes safe, healthy fragrances created with easy to obtain, plant derived oils and delivers them to the therapy jets heads of spa/hot tubs via its aromatherapy chamber and water boost pump plumbing; and to its surrounding air/environment when used in one of its portable, alternative modes. The operation of our invention is as follows: Cap 5 is removed by an upward pushing action from filter housing 8, filter 6 is inserted into filter housing 8 via opening 7, a few pre-selected drops of the safe, natural, plant derived oil is placed on top of filter 6, cap 5 is then replaced by downward pushing motion snapping it into opening 7, thereby securing filter 6, the fragrances can be easily changed by performing the above action in reverse and replacing the filter with a newly scented one. ref. FIG. 18. Our invention is then placed into the aromatherapy chamber of the spa/hot tub. FIG. 22 illustrates the operation of our invention: Forced air from the spa/tub's air blower plumbing enters the aromatherapy chamber, circulates throughout the aromatherapy chamber passing through the air intake/exhaust holes 9 and filter 6 of the invention. The air becomes scented from the natural, plant derived oil applied to filter 6, it then exits the invention through the air intake/exhaust holes 9 and the bottom plate 10. The safe, healthy fragrances created with the natural, plant derived oils exits the aromatherapy chamber and is mixed into the water coming from the spa/hot tubs water boost pump plumbing, then delivered to the spa/hot tub's water therapy jet heads. The fragrances rise to the surface through the bubbling water created by the spa/hot tub's water therapy jet heads, where they deodorize, disinfect and freshen the water and escaping air. When snap-ring 16 ref. FIG. 20g, is snapped to our invention ref. FIG. 20b, it provides a method to attach the delivery system to other self powered air producing devices, offering many portable alternative uses for this invention, ref. FIG. 20c. To enjoy a fragrance created by safe, easily obtained, natural, plant derived oil simply un-snap cap 5, from opening 7, insert filter 6 into opening 7, add a few drops of the safe, natural, plant derived oil to the top of the filter 6, re-snap cap 5 back into opening 7, attach snap-ring 16 to the center of the invention ref. FIG. 20b, then clip to any air vent, air register, in homes, automobiles, RVs, rental cars, hotel rooms, ship's cabins, self powered fans or other self powered air producing devices, ref. FIG. 20c. As air is blown through the invention's air intake/exhaust holes 9 and filter 6, it disperses, diffuses, vaporizes and delivers safe, healthy fragrances, created with easy to obtain, natural, plant derived oils to its surrounding air/environment for the user's enjoyment. Snap-ring 16 can also be utilized as a filter 6 extraction tool when removing or replacing the filter from filter housing 8, ref. FIG. 20d. Cap 5 also serves as a handle for easy removal from the aromatherapy chamber, ref. FIG. 22 and a stand for the invention when used as a free standing air freshener ref. FIG. 20a.

### CONCLUSION, RAMIFICATIONS, AND SCOPE

Thus the reader will see that the portable fragrant air delivery/diffuser system for spas/hot tubs and other self powered air producing devices, that we claim as our invention, provides an extremely durable, easy to use, portable, inexpensive, entry level system that not only works well for its main embodiment, but has many portable alternative uses as well.

While our above description contains many specificities, these should not be construed as limitations on the scope of this invention, but rather as exemplifications of the two embodiments thereof. Other variations are possible, for example a one-piece design, using an injection mold manufacturing process, whereby the vented container is formed in one piece with molded hinges along one seam of the container, while the opposite seam is molded split in half with a locking mechanism which allows the container to open and lock closed to securely hold, change or replace its contents via a side loading/unloading means, or a similar method, where the container itself is injection molded again as one piece, but with a top opening lid having a molded hinge on one side and a snap catch on the opposite side allowing the cap to lock or unlock. This method would allow the contents to be loaded, removed or replaced via the container's top. These methods; however, may be less durable and perhaps not as reliable; however, could possibly be a much more cost effective method, while offering other possible advantages, such as a wider range of colors, a shape change and a built in alternative use clip. Much thought, cost evaluation and market research for this design and manufacturing method are currently being considered and investigated as a serious option in the near future.

Accordingly, the scope of the invention should be determined not by the embodiments illustrated, but by the appended claim and its legal equivalent.

What we claim as our invention is:

1. A portable fragrant air delivery/diffuser system for spas/hot tubs and other self powered air producing devices, comprising:
a. a removable, biodegradable absorbent filter, a portable vented filter housing container sized to fit inside an aromatherapy chamber of a spa/hot tub and means for providing a removable, opening and closure mechanism to said portable vented container, whereby accessing said filter, and
b. an attaching mechanism, and means for providing connection with said portable fragrant air delivery/diffuser system for spas/hot tubs other self powered air producing devices, comprising a snap ring and a jawed clip, said jawed clip is riveted to said snap ring allowing it to pivot freely around said snap ring, whereby having the capability to clip to other self powered air producing devices.
